(19) United States
(12) Patent Application Publication
(10) Pub. No.: US 2004/0051293 A1
(43) Pub. Date: Mar. 18, 2004

(54) Device for detecting the use of a belt and the service life of the restraint systems

(76) Inventor: Giok Djien Go, Idstein (DE)

Correspondence Address: Giok Djien Go, Pfahlgrabenstr 45, Idstein, D 65510, DE

(21) Appl. No.: 10/204,827

(22) PCT Filed: Feb. 2, 2001
(86) PCT No.: PCT/DE01/00611

(30) Foreign Application Priority Data
Mar. 3, 2000 (DE) 100 10 415.0

(51) Int. Cl. B60R 22/00

(52) U.S. Cl. 280/801.1

(57) ABSTRACT

Thanks to a chain of tamperproof evidence of the unbelted passengers, delivered by a device, car-, aeroplane manufacturers or the airlines are acquitted of compensatory damages and medical expenses. Accident data, impact-identity elements of seat belts, warning lights, fuses and time periods of multiple crashes or turbulence-related vibrations are several pieces of evidence to gather arguments for the users and the non-users of the seat belts. The device registers the number of seat-belt uses, belt protractions and blockings. In excess of the predetermined life the warning light flashes and/or requests appear on the multi-info display to replace the worn-out seat belts, belt retractors and/or locking mechanisms. Easily replaceable impact-identity elements of the seat belt, having different threshold values, protect the passenger from injuries in the event, in which an accident almost occurs, or of the accident or in turbulence-related vibrations, thus facilitating the exchange and saving costs by further use of the seat belt which was not overstressed.

This is a continuation-in-part application of co-pending international application number PCT/DE 01/00611 (WO 01/64485, DE 100 10 415 C1) filed Feb. 2, 2001.

### BACKGROUND OF THE INVENTION

1. Field of the Invention

It is an object of the present invention to provide a device for a transport system, equipped with-restraint systems, to monitor and record the users and non-users of seat belt during a journey and in the event of a real-world accident, determine the life of each restraint system by counting the seat-belt uses, the belt protractions (withdrawals) and the blockings, dissipate great belt force by fracturing impact-identity elements, which serve as evidence of the seat-belt use in the accident and issue a chain of evidence of uses and non-uses of seat belts and accident data as well as to provide a method to protect the chain thereof and data from manipulation.

2. Description of the Related Art

It is known in the prior art to equip a buckle assembly with a device ref to U.S. Pat. No. 4,702,492, delivering evidence of manipulation, use and non-use of the seat belts in the event of a real-world accident, provide a device ref to U.S. Pat. No. 5,119,407 and U.S. Pat. No. 4,667,336 for a motor vehicle to detect seat-belt use, equip a buckle assembly with a device ref to DE-A 41 40 115 to detect excessive elongation of seat belt, which can be used for evidence of seat-belt use, monitor by means of a device ref to DE-B 21 14 504 the seat-belt use in dependence on the seat occupancy and exploit a floor fitting, broken by large energy, ref to DE-C 3 801 858 for evidence of seat-belt use. However, the deficiencies thereof, herein explained, discourage car- and aeroplane manufacturer to find a use therefor.

In order to formulate in single terminology a generalized definition for the proper term is presented:

| Definition: | Proper Term: |
|---|---|
| ″transport system″ | motor vehicle (car, school-bus, bus, |
| | truck), train (commuter train) or aeroplane |
| ″time-dependent | yaw-speed,,Å_{z}” about the zₛ-axis, pitch- |
| differentiation of rotatory | speed ,,Åₓ” about the xₛ-axis and roll- |
| angle,,Aₓ”, ,,A_{y}” and ,,A_{z}”″ | speed ,,Å_{y}” about the yₛ-axis of the |
| | point of gravity ″S″ of transport system |
| | (FIG. 4) or yaw-acceleration,,Å_{z}”, roll- |
| | acceleration ,,Å_{y}” and pitch- |
| | acceleration,,Åₓ” |
| ″accelerometer″ | sensor or control device |
| ″belt-protraction markers″ | colours, codes, metal strips or pattern, |
| ″real-world accident″ | real-world accident or turbulence-related |
| | flight (incident, vibration) |
| ″identification markers″ | different colours or different widths or |
| | different patterns. |
| ″seat-belt user″ | passenger (baby, child or adult) buckles up |
| ″belt fitting″ | latch plate 2, 9, 9a, 11, coupling member |
| | 1.30, 1.30e, floor fitting 17, 17a, |
| | 17b or D-ring 12 |

Passengers must buckle up when travelling with a motor vehicle, with the exception of school-bus and bus, or during a turbulence-related flight of an aeroplane. It is well known to provide two-point or lap seat belts for mid-portion of the rear seat of vehicle as well as for aeroplane seats. The protective effect of this lap seat belt is far less than that of a three-point seat belt in accidents.

Unfortunately, three-point seat belt insufficiently restrains the unsymmetrically belted passenger in real-world accidents.

Moreover, by the definition of “submarining” the restrained passenger submarines (slips downward) under his seat belt thus negating the protective effect of the seat belt. The expert came to the conclusion that the passenger had not used the seat belt.

It is well known to absorb impact energy in co-operation with three-point seat belt, exemplified by a delimiter-device such as floor fitting ref. to DE-C 3 801 858 and by other energy-absorbing devices, each of which is fastened to side rail. In a rollover, in a rear- or front collision, in which the yaw-acceleration is great, the three-point seat belt is incapable of properly restraining the passenger. Because energy-absorbing parts thereof remain unbroken, there is no evidence of the passenger, having used the seat belt.

It is well known to employ energy-absorbers in association with three-point seat belt or multi-point seat belt (FIG. 4) for motor vehicles, trains and aeroplanes. Upon the use of the multi-point seat belt in co-operation with a shoulder cap and upon the plug-in connection of a latch plate 11 of lap belt 1.3 with one of buckle assemblies 8, 8a to 8d the energy-absorbers are broken in any accident so the fracture thereof is incontestable evidence of the use of the seat belt. Unfortunately, there are no laws to enforce the use of shoulder caps and the plug-in connection of latch plate 11 with buckle assembly 8, 8a to 8d. Thus, it can happen that energy-absorbers remain unbroken in the rollover or rear collision.

DE-U 298 12 934 and DE-U 296 13 291 disclose devices to monitor the latching position in the buckle assembly for motor vehicles and aeroplanes, respectively.

Exemplified by DE-B 21 14 504, a device monitors the seat-belt use in dependence on the seat occupancy. In case of non-use thereof a visual and/or acoustic signal warns the seat occupant.

DE-A 195 15 190 teaches a method of examining the function of an airbag-generator of motor vehicles by means of an auxiliary CPU, which controls and evaluates data, in order to monitor the main CPU.

U.S. Pat. No. 4,702,492 (DE-A 35 13 339) teaches a buckle assembly equipped with a device, delivering evidence of manipulation (tampering), use and non-use of the seat belt in the event of a real-world accident, which comprises a low-pass filter, a belt switch, wired to a fuse, and a measuring cell (pull switch), wired to another fuse. In a real-world accident the cell, measuring the belt force, resulting from the mass force of the restrained passenger, permits the current to flow to the fuse and blow it when exceeding a predetermined mass force, serving as a threshold value. In a real-world accident the sensor emits an electrical signal via the low-pass filter to the cell- and belt-switch entrance, thus resulting in one of four cases, which depends on the state of both fuses in order to determine a manipulation, use or non-use of the seat belt. The use of seat belt is confirmed when the fuse of the cell is destroyed while the fuse of the belt switch r remains intact. In the following cases no evidence is found because the fuse of the cell remains intact due to less mass force of a child, a woman or a 70 kg-heavy man, when the cell is adapted to a 140 kg-heavy man, or in real-world accidents at speed lower than 120 km/h, when the cell is set to a crash-speed of 120 km/h.

In case that the cell is set to a 50 kg-heavy child and a crash-speed of 100 km/h, the fuse melts due to the mass force of a 100 kg-heavy woman, when her car, speeding at over 70.7 km/h, is emergency stopped or in the event in which an accident almost occurs. These features make manipulation possible. If the vehicle, whose fuses were already burnt out, is further used and involved in an accident, the unrestrained passengers can convince the court and police that they were wearing the seat belts.

One of the three world-wide largest car manufacturers recently recalled 1.4 million motor-vehicles, built in 2001, due to defective plug-in connection of latch plates to conventional buckle assemblies.

Buckle assemblies, designed with all those features, are increasingly prone to failure, expensive recall actions and repair. As a result, evidence for courts is useless. Parts of buckle assembly in addition with the measuring cell, chain of connection and fuses will not fit into the housing thereof.

Owing to very modest features, which don't need low-pass filter, measuring cell and second fuse, the design of buckle assemblies remains unchanged, the claims 1, 2, 3 or 4 delivers an evidence of the uses or non-uses of seat belts and the claims 8, 25 and 30 issue a chain of tamperproof evidence.

Both U.S. Pat. No. 5,119,407 and U.S. Pat. No. 4,667,336 teach a detection of seat-belt use and an odometer therefor. The car owner with a large number of seat-belt uses should be rewarded with an incentive to pay less for the car insurance premium. A current line is arranged along each belt portion of the latch plate and buckle assembly. When plug-in connected, current, flowing therethrough, actuates the counter. Unfortunately, manipulation can be done by plug-in connection.

In response to great forward motion of a belted, heavy passenger both belt portions elongate, thus tearing both current lines apart.

The floor fitting ref to DE-C 3 801 858 is laid out for tensile load and a single, large threshold value of male ribs at 8000 N during which female ribs at 6000 N and ribs of old people at 4000 N and internal organs are fractured. Subsequently, large remaining energy destroys the body. Contrarily, each impact-identity element with a plurality of sites of predetermined fracture is laid out to optimize the material and dissipate lower subenergies, the sites of predetermined fracture are laid out for compressive load, each impact-identity element of set 1.3S (FIG. 13) has half the elongation of the floor fitting and energy-absorbing impact-identity elements dissipate lower sub-energy “ΔFᵢ”, where i=1 to n, at threshold values lower than the injury-related load.

A device ref to DE-A 41 40 115 consists of two retaining parts, movable in each other, one of which is fastened to the buckle assembly and the other is fastened to the vehicle floor, and of a pair of clamping pieces which are retained in the apertures of the retaining parts, predetermined biased by expensive coned-disk springs. To prevent manipulation both retaining parts as well as clamping pieces are tamperproof-capsuled. Due to excessive elongation of seat belt at load over 24 kN, larger than the predetermined biased force, both clamping pieces fall out therefrom There is no doubt that the excessive elongation can be presented as evidence for seat-belt use but the enormously large load over 24 kN causes severe/fatal injuries, fracture of internal organs and bones.

Manipulation can easily be done by loading all seat belts over 24 kN. Therefore, unbelted passengers have for ever au evidence of “seat-belt use”, very usefull for lawsuits.

A well-known control device, disclosed in DE-A 43 40 719, which can be found a use for a control device 55 (FIG. 3), senses the yaw-speed of motor vehicle and attempts to control the vehicular direction by asymmetrical braking, if the motor vehicle is out of control due to the driver or cross wind.

Obviously, court-incontestable (tamperproof) evidence of the users of seat belt are missing in the following cases in the event of real-world accidents:

It has happened in the offset front-, side- or rear collision, which results, finally, in rollovers, that a passenger, having got free from the restraint, is ejected out of the vehicle, whose doors are detached, during a rollover. This phenomenon is substantiated in the research work of the inventor, investigating various vehicles of different car manufacturers in accidents. Because sensors are incapable of precisely determining deceleration in the event of rollover, side- or rear collision, it can occur, that the belt tightener (pretensioner) 190 doesn't retract the belt portions 1.2, 1.3 and/or the locking mechanism 14 (FIG. 4) doesn't block (forcefully tighten) the belt portion 1.4. Despite having used the seat belt no blocking traces thereon are discovered.

The steering wheel and steeling column, totally deformed by the head of driver, thrown forward, leads the traffic experts to believe that the seat belt was not used in the accident. A microscopic investigation confirms the blocking traces on the surfaces of belt portion 1.4, which was jammed (blocked) by the locking mechanism 14 during a forceful protraction of belt portions 1.2, 1.3 by the belt tightener 190 in the front collision. However, such investigation results are questionable because these traces could be caused by soft clampings of both clamping shoes before the collision has taken place.

When traces, resulting from the friction of the belt portion on the surface of a plastic material 9.11a of latch plate 9, are not detected, traffic experts make verdicts that passengers had been unbelted.

By great energy during a turbulence-related flight of a jumbo jet the unbelted passengers as well as the majority of passengers, belted by life-threatening lap belts, are severely/fatally injured. After rescue and medical treatment no one of the flight personnel can remember anymore who had been belted and unbelted. The airline has no choice but to pay all the medical expenses of all injured passengers, some of them ignored the request to buckle up. There is no device for recording the unbelted passengers during flights.

Upon the restraint of passenger the belt portion, deflected by the D-ring, is retracted or protracted by the belt retractor having a locking mechanism, which is activated in excess of the respective threshold values in order to intercept the upper part of his body, thrown forward, thus softly (gently) clamping the belt portion in response to low deceleration when driving slowly or blocking the belt portion in response to high deceleration in an accident or when driving fast.

In the bench test belt retractors must capable of 100,000 belt protractions and locking mechanisms 20,000 blockings under the periodical load of ±300 N. In the 50% offset crash tests of various European vehicles at 55 km/h belt forces are measured from 3,000 to 9,130 N while airbags are optimally deployed. In response to fast, hectic driving a great number of blockings under large belt forces is achieved. The seat belt and the pair of clamping shoes (clamping rolls) of the locking mechanism show strong wear, which substantially impairs the protective function, thus enlarging the forward motion of the upper part of body in the real-world front collision during which the head is crushed by the properly deployed airbag and/or deforms the steering wheel. The head is injured. When both surfaces of the belt webbing are worn out, the friction coefficients, to block the belt webbing by the clamping shoes, significantly decrease, for example from 0.8 to 0.1, and inhibit the restraint of passengers in accidents. In the event of a rollover the passengers, being easily freed from the respective restraints, are thrown against parts of the vehicle or aeroplane. No Administrations determine the life of restraint systems, hence, car-, aeroplane manufacturers or airlines are responsible for the failure thereof

There are no laws (regulations) to specify the life of the parts of restraint systems as well as the replacement of the worn-out parts.

### SUMMARY OF THE INVENTION

Accordingly, the principle object of the present invention is provide for a transport system a device to monitor, record the users and non-users of seat belt, determine the life of restraint systems by counting the seat-belt uses, the belt protractions and the blockings and issue a chain of evidence of uses and lion-uses of seat belts and accident data as well as a method of protecting the chain thereof and data from manipulation.

A second object of the present invention resides in impact-identity elements to gradually dissipate great belt force by fracturing sites of predetermined fracture, which serve as evidence of the seat-belt use in the accident, in excess of the respective threshold values, and/or by totally deforming them.

A third object of the present invention resides in the device to register the start and the end of a journey as well as the time of an accident and crash speed.

A fourth object of the present invention resides in a method to exploit existing parts, which are already put to use in motor vehicles or aeroplanes, for further application in order to save Research- and Development work and manufacturing costs as well as to increase the reliability of the device.

### SUMMARY OF THE ADVANTAGES OF THE EMBODIMENTS

A single device according to claim 1 fails to record onset of the accident, in particular, time periods of several accidents or several turbulence-related vibrations. Moreover, the impact-identity elements, broken by large mass force resulting from several emergency stops or in the event, in which ail accident almost occurred or has occurred, can be improperly used for an evidence of seat-belt use when an accident occurs.

Upon the use of a single device according to claims 2 or 3 the indicators are melted by strong current when airbags are falsely deployed or no indicators are melted when airbags are not deployed. When they are not replaced unbelted passengers have for ever a court-evidence of “seat-belt use”. In several crashes of a one-year old German Premium car at 150 km/h into barriers and in the crash of a four-month old German car at approx. 110 km/h into a mid-barrier all airbags are not deployed. Over two millions of cars, among them MBs, Volvos and Porsches the safest in the world, were already recalled thus making a single device unsuited for the service to create conclusive evidence due to its conventional sensor which can improperly sense a predetermined deceleration serving as threshold value.

Upon the use of a single device according to claim 4 the time periods of plug-in connection of the latch plates with respective buckle assemblies and the onset of the accident or time periods of several accidents or several turbulence-related vibrations are recorded. Unbelted passengers, making an attempt at tempering by plug-in connecting the latch plates to respective buckle assemblies, take a stroll along the aisle of an aeroplane or seat on their seats and seat belts.

A US Court sentenced a car manufacturer to pay the highest damages of 259 millions of dollars to the parents of a kid, who, presumably unbelted, was ejected out of the tailgate of minivan. In compliance with reversal of the burden of proof in USA manufacturers have to file to courts competent evidence. Evidently, car manufacturers are exposed to lawsuits resulting from the high rate of non-uses of seat belts by 29% on US roads as well as on Canadian roads as police, checking the use of seat belts a suburb of Vancouver, issued violation tickets to 90 non-users within four hours. Lawsuits can only be avoided when they possess a chain of tamperproof evidence which can be accomplished only during the event of a real-world accident by four embodiments, all of which act as an objective accident-expert, according to claim 8. This objective accident-expert, when working, is more reliable and accurate than experts who issue expert-reports (expertise) when the accident is all over. Up till now no chain of evidence, but a number of expert-reports, in which arguments and counter-arguments as well as hypotheses are exchanged, is filed to the court.

The device according to claim 4 reinstates only the time periods of plug-in connection of the latch plates with respective buckle assemblies if sensors don't emit no electrical signal. An additional evidence is required for non-uses of seat belts. In contrast to the belted co-driver a belted driver is ejected out of i two-year old German car, rolling over, due to excessive elongation of his seat belt and free movement of his unrestrained shoulder. An expert, making an investigation on behalf of the Office of Prosecutors, writes in the report the verdict of seat-belt use based on his finding of traces of melted plastic caused by the friction of the belt portion on the surface of a plastic material 9.11a of latch plate 9. However, these traces could result from large deceleration linked to several emergency stops or in the event, in which an accident almost occurs, prior to the rollover-accident. The expert report were beyond doubt if impact-identity elements with a plurality of sites of predetermined fracture according to claim 1 were put to use. Those having threshold values, lower than the loads responsible for excessive elongation and traces, were broken. Upon use precautions prior to an accident must be taken to avoid manipulation and replace broken impact-identity elements for example at inspection-service and seal them.

The above-mentioned circumstances substantiate the need for a reliable device as well as for a method to protect the chain of evidence and data from manipulation according to claims 8, 25 and 30. Thanks to the chain of tamperproof evidence manufacturers will be acquitted of compensatory damages and medical expenses by courts.

In event of a rollover and/or a rear-end crash passengers, when freeing themselves from the restraint of conventional three-point seat belts, can be ejected out of a vehicle due to interengaging assemblies of the doors. In order to enhance the chain of evidence and survival chance it is recommended to use multi-point seat belts ref to U.S. appl. Ser. No. 09/544,463 (CA 2,313,780, EP-B 1 037 773), preferably in association with the shoulder caps, equipped with energy absorbers serving as additional evidences, ref to U.S. appl. Ser. No. 09/544,464 (CA 2,314,345, EP-B 1 037 771), interengaging assemblies ref to U.S. appl. Ser. No. 08/860,182 (CA 2,220,872, EP-B 0 869 878) and the device, equipped with control device 55, according to claims 8, 25 and 30.

The device registers the onset of accident as well as time periods of multiple crashes or multiple turbulence-related vibrations.

The accident data, impact-identity elements of seat belts, warning lights and fuses are several pieces of evidence to marshal arguments for the users and the non-users of seat belt in any accident.

The device registers the number of seat-belt uses, belt protractions and/or blockings. In excess of the predetermined life the warning light flashes and/or earnest requests on the multi-info (multi-information) display (screen) warn to replace the worn-out seat belts, belt retractors and/or locking mechanisms.

By typing in the names or initials of all passengers the device registers their seat occupancies in the aeroplane, vehicle or train. Owing to this feature the passengers can immediately be identified despite being beyond recognition resulting from severe/fatal injuries or burns in the accident and the respective family members can immediately be informed.

Easily replaceable impact-identity elements, which are broken for the purpose of protecting the passenger from injuries in the event, in which an accident almost occurs, or in turbulence-related vibrations, facilitate the exchange and save costs by further use of the seat belt because it was not overstressed.

Energy-absorbing impact-identity elements lower injury severity. The addition of all subenergies (specific amount of loads) “ΔFᵢ”, where i=1 to n, results in the belt force “Fₙ”.

Thanks to sets of energy-absorbers to dissipate great belt force specific proposals can be realised by assigning impact-identity elements, for example, on dissipating lower sub-energy “Δhd i”, where i=1 to n, at the injury-irrelevant threshold values, which are lower than the injury-related load.

By grouping light- to heavy-weight passengers into weight classes sets of impact-identity elements, having the corresponding threshold values, can be designed and offered. To restrain for example a 35 kg-heavy child the set of impact-identity elements, proposed for a 8 kg-heavy baby, will be substituted by a set thereof suited for 35 kg.

Different colours, patterns and/or widths facilitate traffic experts and police officers to examine the fracture of the impact-identity elements and determine the passengers, whose mass forces are related to the broken impact-identity elements, in particular when they are ejected out of the vehicles in a multiple crash.

Under the condition of the same length (FIGS. 11, 12) the elongation (deformation) “Δw” of the belt-looping string at the break has half the elongation “2Δw” of the belt webbing at the break. Advantageously, this feature reduces the forward motion.

In order to minimize the forward motion, belt-looping strings 1.3in with sites of predetermined fracture are made of material, characterized by little elongation at break (rupture) less than that of the belt webbing, such as compound material, metal or fibre-reinforced material.

For the purpose of dampening noises upon the contact with belt fitting 2, 17, 17a, 17b (FIGS. 7, 11, 13) the first belt-looping string 1.3i1 is made of belt webbing, soundproofing material and/or the impact-identity element 17.1 is made of soundproofing material.

### BRIEF DESCRIPTION OF THE DRAWINGS

A number of embodiments, other advantages and features of the present invention will be described in the accompanying drawings with reference to the xyz global coordinate system:

FIG. 1 illustrates a block diagram (flow chart) of a 1st and 2nd embodiment of a device.

FIG. 2 illustrates a block diagram of a 3rd and 4th embodiment of a device.

FIG. 3 illustrates a block diagram of a 5th and 6th embodiment of a device equipped with a screen, micro computer and PC (computer).

FIG. 4 is a perspective view of the screen, having micro computer, and of a seat, equipped with sensors, a restraint system ref to EP-B 1 037 773, comprising a multi-point seat belt, belt tightener, belt retractor, locking mechanism, latch plates and buckle assemblies, arranged in the backrest and seat cushion.

FIG. 5 illustrates a force-elongation graph, where the belt force “Fₙ” is dissipated by impact-identity elements in dependence on the elongation “wₙ” in an accident.

FIG. 6 is a perspective view of a conventional three-point seat belt equipped with a belt tightener.

FIG. 7 is a perspective view of a 1st embodiment of an impact-identity element.

FIG. 8 is a top view of a 2nd and 3rd embodiment of an impact-identity element of a latch plate.

FIG. 9 is a cross-sectional view of a 4th embodiment of an impact-identity element of the latch plate taken along the line I-I of FIG. 8.

FIG. 10 is a cross-sectional view of a belt fitting having three impact-identity elements.

FIG. 11 is a perspective view of the 1st embodiment of the n-impact-identity elements.

FIG. 12 is a side view of a developed projection of the n-impact-identity elements of FIG. 11.

FIG. 13 is a perspective view of a 5th embodiment of a replaceable set of impact-identity elements.

FIG. 13a is a perspective view of a replaceable coupling member of the multi-point seat belt equipped with an impact-identity element.

### DESCRIPTION OF THE PREFERRED EMBODIMENTS

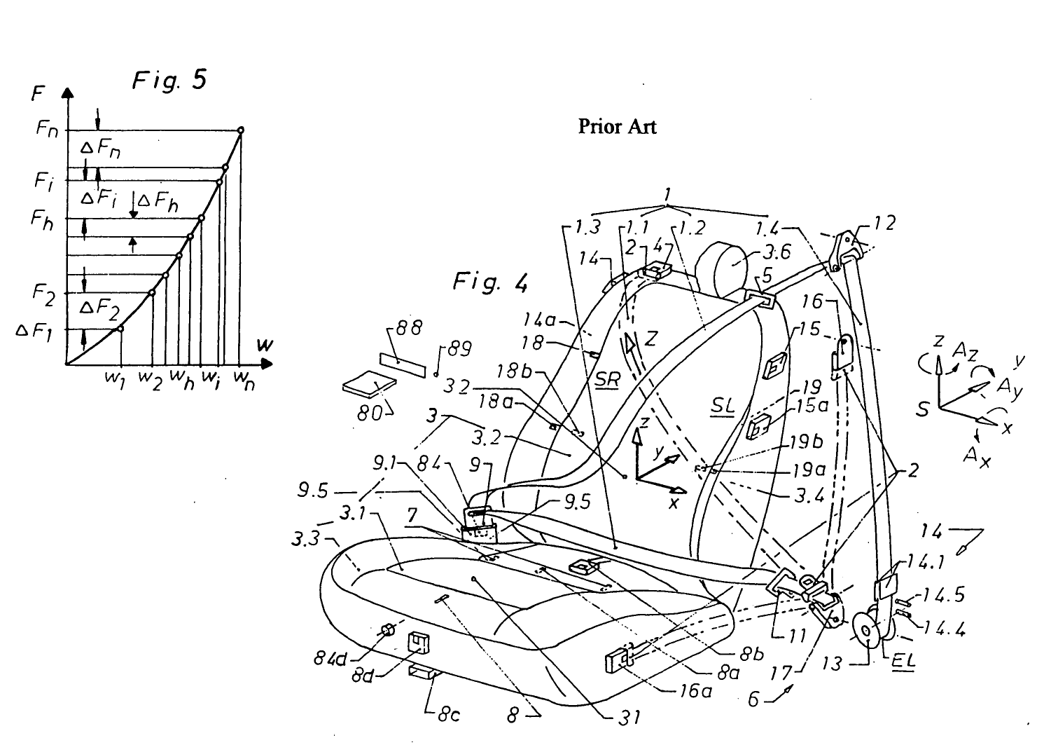

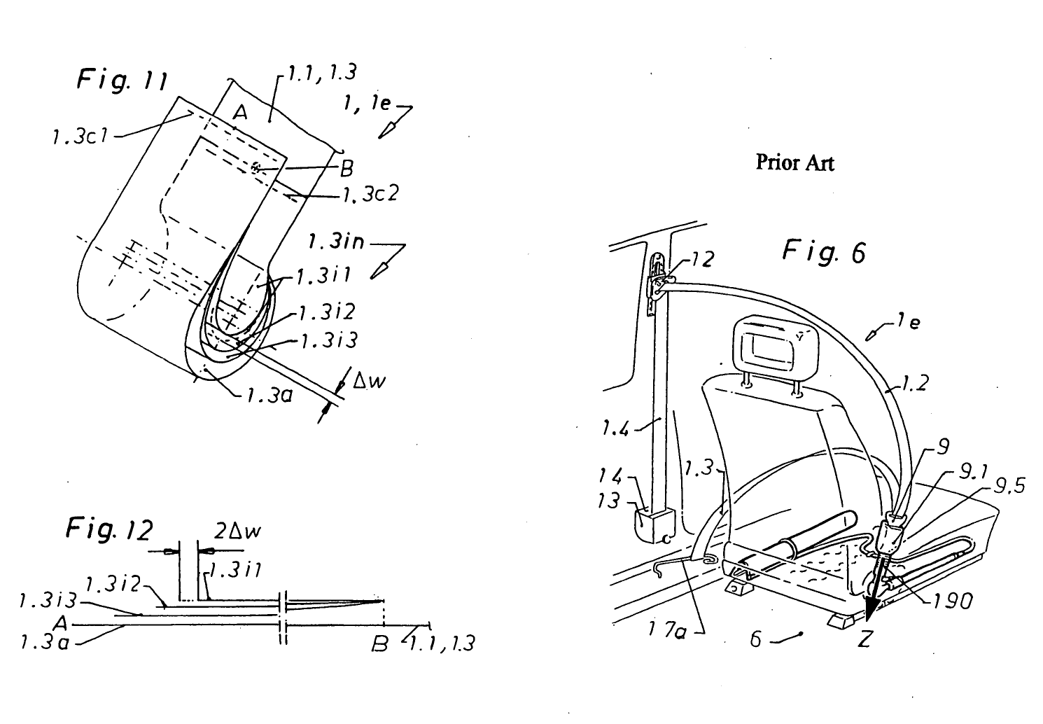

Each device is suited to monitor and record the users and non-users of seat belt of a transport system, is equipped with two-point-, three-point seat belts 1e and/or multi-point seat belts 1 (FIGS. 4, 6).

The one-piece multi-point seat belt 1 differs from the three-point-seat belt 1e by restraining the upper part of body of the passenger in an X-shaped configuration of shoulder belt portions 1.1, 1.2 and by plug-in connecting the latch plate 11 of lap belt 1.3 to one of the buckle assemblies 8, 8a to 8d to restrain both thighs in order to prevent submarining. The safest, but most expensive restraint system is provided with the belt tightener 190 as well as the locking mechanism 14 of belt retractor 13.

The mode of the operation of each device is independent of whether the unreliable airbag is deployed or not in an accident. In order to fire gas pellets of the airbag by means of the ignition apparatus (generator) 53 in an accident the current (current intensity, amperage) in the electric line (conductor) 71 must be very high (strong). This property is exploited to burn out (blow, destroy, melt through) the warning light 62 of the electric line 75 and the fuse 61 thereof, which is dimensioned far weaker than the fuse 51 of the ignition apparatus. Usually, currents, for sensors of belt tightness and/or locking mechanisms, are dimensioned far lower than of that the firing current. As long as they are capable of burning out, they can be put to use too, thereby making the fuse 51 superfluous.

Conventional sensor of airbag can properly operate in longitudinal direction within a range of deviation angle of ±20° in the event of a front collision. It becomes unreliable in operation when the deviation angle becomes larger. So there is a need to invent a device 30e. Whether the coming 3-D sensor is more reliable than the present, must be proven in practice.

Unfortunately, the 3-D sensor is not designed to measure the yaw-, pitch- and roll-speed or the yaw-, pitch- and roll-acceleration. There is a need for a control device 55 to register accidents or turbulence-related vibrations by sensing the time-dependent differentiation of rotatory angle “Aₓ”, “A_{y}” and “A_{z}” about the xₛ-, yₛ- and zₛ-axis of the point of gravity “S” of the transport system in excess of the respective threshold values. The well-known control device of motor vehicle, above-mentioned, or any well-known control device of an aeroplane can be put to use.

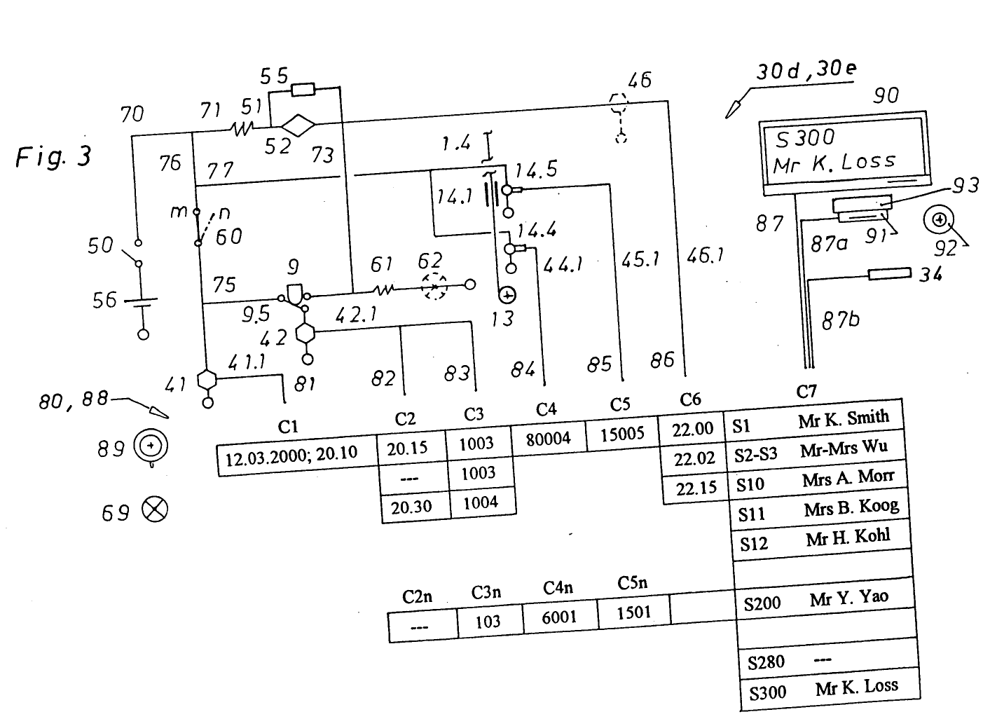

In order to facilitate the device 30, 30a to 30e to record multi-crashes during a journey or multi-turbulence-related vibrations during a flight, a reusable control device 55 and 3-D sensor 52 (FIG. 3), such as the reusable sensor disclosed in U.S. Pat. No. 5,237,134 (DE-A 41 43 032), are required. After registering both devices 52, 55 are able to return from the operation position to the resting position, serving as home position.

The device 30, 30a to 30e consists of

warning lights (LEDs abbreviation of Light Emitting Diodes, lamps, bulbs and the likes) serving as control indicators for “buckle up now”;

fuses 61, 61a;

belt switches 9.5, 9.5a, located in the buckle assemblies 9.1, 9.1a;

sensors 52, 52a and control device 55, all of which have the function of emitting (releasing) current in an accident;

sensors 14.4, 14.5 of locking mechanism 14 and/or

microprocessor (micro computer) 80 having program, which records the data “start of journey/flight, time of accidents/turbulence-related vibrations, use of seat belts, life of restraint systems etc.”, stores in a large storage medium or RAM 80.1 (not shown) and updates;

output equipment such as printer 93 and screen 88, at which certain data appear upon activating an operating knob 89;

read- and/or write-equipment such as printer 93, disk drive (streamer) 91 with storage disc 92 (magnetic belt, floppy disc or Zip disc, CD R-W, CD-ROM, DVD-ROM etc.) and/or

PC (computer, laptop, notebook) 90 and/or blackbox 34 of aeroplane.

Upon the plug-in connection of the latch plate 9, 9a with buckle assembly 9.1, 9.1a the belt switch 9.5, 9.5a, serving as monitoring switch (-relay) to supply current to warning light flashing “buckle up now” and as signal transmitter, interrupts the current in the electric line 75, 75a and reroutes to a signal transmitter 42.

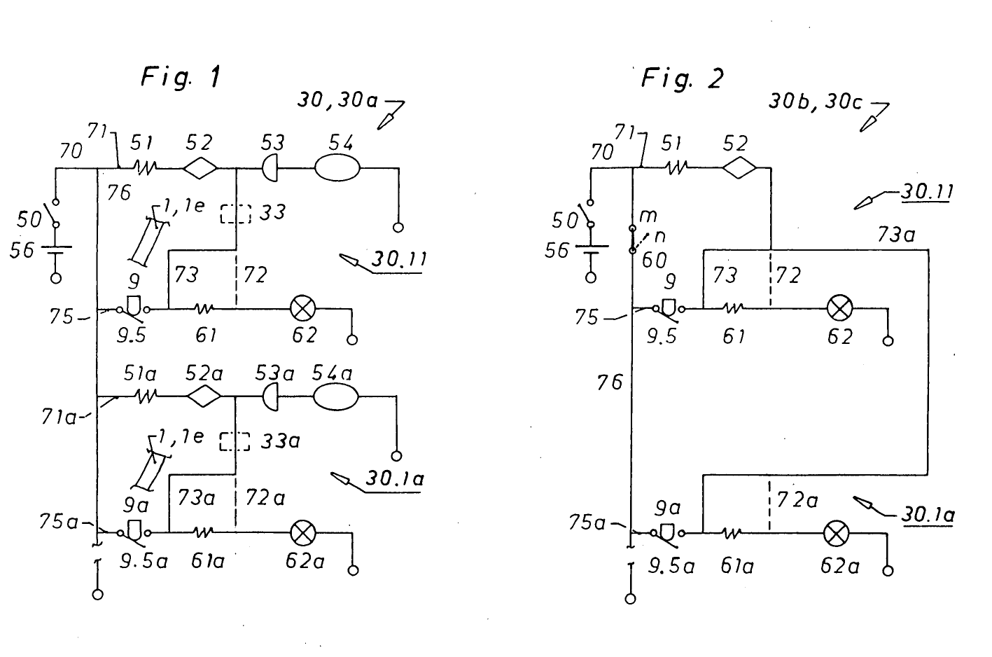

Each device is defined by a number of control units 30.11 to 30.1a or 30.11 to 30.1a, where the index “a” denotes the number of passengers, for which the transport system is designed (FIGS. 1, 2).

Nowadays, the screen (multi-info display), displaying time, broadcasting station, date, exterior temperature, speed, gasoline consumption, check-control and the likes, the microprocessor to process multi-info display, motor-management and the control device are standard parts of vehicles as well as aeroplanes. The screen of navigator is also suitable for device 30d, 30e.

Manufacturing costs are slightly increased by further use of the existing microprocessor, by extending the software and by enlarging both storage media such as RAM 80.1 and ROM 80.2 (not shown).

When switched on, a current-control switch (ignition switch of motor vehicle) 50, connected to the main electric line 70 of battery 56, the warning light lights up to request to “buckle up now”, which is switched off either by inserting the latch plate 9 into buckle assembly 9.1, thus activating the belt switch 9.5, or by a dwell time (time-delay) relay (not shown) in excess of a dwell time. The device is able to record the users and non-users of seat belt in accidents. Moreover, the warning lights such as LEDs, the fuses and the microprocessor must be designed for a very long life, preferably, longer than that of vehicles or aeroplanes, or must be replaced in time in order to maintain the service.

In the 1st or 2nd embodiment of the device 30 or 30a, shown in FIGS. 1 or 2, the electric line 71, 71a is connected to electric line 75, 75a via an electric line 72, 72a or 73, 73a. In excess of a deceleration at the level of the threshold value in an accident the sensors 52, 52a emit strong currents, which overload and burn out the warning lights 62, 62a of the restrained passengers upon the use of the device 30 or the warning lights 62, 62a and fuses 61, 61a of the restrained passengers upon the use of the device 30a.

Contrarily, the warning lights and/or fuses (not shown) of the unrestrained passengers remain unaffected.

In the 3rd or 4th embodiment the device 30b or 30c, shown in FIG. 2, is provided with a single sensor 52, preferably a 3-D Sensor, to save costs. In excess of a deceleration at the level of the threshold value in accidents the sensor 52 emits strong current, which overload and burn out the warning fights 62, 62a of the restrained passengers upon the use of the device 30b or the warning lights 62, 62a and fuses 61, 61a of the restrained passengers upon the use of the device 30c.

Contrarily, the warning lights and/or fuses (not shown) of the unrestrained passengers remain unaffected.

Pilots of jumbo jet are bust with monitoring and controlling a large number of warning lights and screens. They would get irritated by additional flashing warning lights 62 to monitor, for example, 300 passengers, particularly, at the take-off of the jumbo jet. On the other hand the warning lights help the traffic expert examine whether the passengers had been belted or unbelted in the event of the turbulence-related vibrations, the accident or at the start; and the pilots monitor the passengers in response to the instruction to “buckle up now”. Alternately, the device 30, 30a to 30e is provided with the following features:

The above-mentioned problems are resolved by a master belt switch 60, interposed in the power-supplying line 76. When the current-control switch 50 is switched on and the belt switch 60 is switched on to the position “m” the current flows to the belt switches 9.5, 9.5a or off to the position “n” the current-flow is interrupted thereto.

The feature with the fuses 61, 61a without warning lights makes impossible to monitor the use and non-use of seat belts.

In the 5th or 6th embodiment the device 30d or 30e, serving as control unit, with regard to the block diagram, shown in FIG. 3, comprises

the microprocessor 80, equipped with RAM 80.1 to store data, an I/O (Input/Output) interface, ROM 80.2 (not shown) and a program 80.3 to transform signals into data and to evaluate it;

the screen 88, on which the data appear in row and/or column upon request by activating the operating knob 89;

the 3-D sensor 52, control device 55, disk drive 91, printer 93 and/or PC 90;

a warning light 69, an acoustic and/or vocal means to request the replacement of the parts of restraint systems.

Both sensors 14.4, 14.5 are supplied with current via the electric line 77. In excess of a threshold value a signal flows.

In operation by switching on the current-control switch 50 the device 30d, 30e generates the following data during the journey, flight or in the event of the accident:

The row in column “C1” on the screen shows the date and the start of a journey or a flight upon switching on the current-control switch 50, whereby the current flows through a signal- or impulse transmitter 41 of the power-supplying line 76, emitting to the signal line 81 an electrical signal or impulse 41.1, which is transformed by the program to set the date and the start thereof at “20.10” o'clock.

The rows in column “C2” and “C3” on the screen show the time periods of belting on at “20.15” o'clock, of belting off by “ - - -” and of belting on again at “20.30” o'clock and the number of seat-belt uses about “1003” and “1004”. By inserting the latch plate 9 into buckle assembly 9.1 the belt switch 9.5 interrupts the current flow to the fuse 61 and reroutes to the signal transmitter 42. The current is transformed by the program into a signal 42.1 setting the time of seat-belt use and counting the seat-belt uses.

The row in column “C4” on the screen shows the number of belt protractions out of the belt retractor 13. To register each belt protraction out of the belt retractor 13 the sensor 14.4 emits in the signal line 84 the electrical signal 44.1, which is transformed by the program to count the belt protractions. Belt protraction is counted when a belt-length is exceeded. The life of the belt retractor 13 is shortened by the frequency of retractions and protractions. To register the belt protraction each belt-length is provided with a pair of colours, metal strips, codes or patterns.

The row in column “C5” on the screen shows the number of blockings of the belt portions 1.4, achieved by the both clamping shoes 14.1 of the locking mechanism by means of the sensor 14.5 in excess of a predetermined deceleration. The signal 45.1, emitted by the sensor to the signal line 85, is transformed by the program to count the blockings.

The row in column “C6” on the screen shows a registration of the time of multi-collisions or multi-turbulence-related vibrations by means of the sensor 52 and/or control device 55 in excess of a predetermined deceleration and/or a predetermined rotatory speed. The electrical signal 46.1 in the signal line 86 is transformed by the program to register the time of collision or turbulence-related vibration. Having accomplished the registration the sensing mass 52.1 (not shown) automatically returns from the operation position to the resting position. After each registration the sensor 52 or control device 55 is ready for the next registration. A new registration of data “C6”, which is the next, occurs in repeated excess of the predetermined deceleration and/or rotatory speed. After securing the vehicle, involved in the accident, into custody or after the landing of the aeroplane the record, serving as evidence, is saved for courts, police and airlines, respectively.

If necessary, the fuses 61, 61a, warning lights 62, 62a and/or the accident data, stored in the blackbox 34 of aeroplane, serve as additional evidence.

The rows in column “C7” show the names and seats of the passengers, accessible to the flight personnel and helpful for identifying the passengers, particularly in an accident or in case, that the aeroplane is hijacked and catches fire. On check-in and handing out boarding cards the names of the passengers are typed, in reference to the seats, into the PC 90 at a terminal of airport. The data are made accessible for the microprocessor via the data line 87. In case that direct data lines to aeroplanes are not available in terminals, the data are, at first, stored in the storage disc 92, later on, read in by means of the disk drive 91 and, finally, stored in the microprocessor via the data line 87a. The disk drive can be a part of the microprocessor 80.

The row in column “C2n” on the screen certifies the non-user of belt “Mr Y. Yao”, seating on the seat No. “S200”, this resulting in severe injury in the accident. The device 30d, 30e enables motor vehicle owners, train-operators, airlines and police to check the life of restraint systems and to take precaution before an accident occurs. If the current intensity is too strong for the microprocessor, a signal transmitter 46, dotted-line drawn, is installed therebetween.

When restarting the data of the columns “C1”, “C2” and “C7” can be deleted either automatically or by activating the operating knob 89. However, in an accident the data must be protected from deletion.

In order to prevent manipulation, the impact-identity elements, serving as evidence of an accident, such as burnt out warning lights 62, 62a, burnt out fuses 61, 61a and/or accident data, stored in the microprocessor 80, must be protected from unauthorized persons. Beyond doubt, blackbox 34 of aeroplane is suited therefor. In any accident, in particular in multi-turbulence-related vibrations, the program 80.3 always triggers the signal 46.1 to register the accident data in column “C6”. A backup process is solely initiated by the 1st signal 46.1 in order to avoid all accident data, stored in RAM 80.1, from being overwritten or deleted and/or to automatically store all accident data in the storage disc of blackbox 34 via the data line 87b and/or in the storage disc 92 via the data line 87a.

In excess of threshold values of seat-belt use, belt protractions and/or blockings the warning light 69, if necessary, equipped with acoustic tone (sound) and/or vocal message “replace the respective parts of restraint systems”, lights up and/or the message “replace . . . ” appears on the screen 88.

Instead of warning light 69 an additional warning light 62x can be utilized. If this feature is classified very important for passenger protection, the program of the microprocessor in association with the motor-management has to restrict further journey, for example a limitation of 100 km is sufficient to reach a near-by garage. Without sensor the device 30e generates the data listed in the columns “C1” to “C5” and “C7”.

In order to ensure all the data from a succession of travels (flights) and the accident, the microprocessor must have a large storage capacity to save a large amount of data in the RAM 80.1. When the storage medium is full, the program 80.3 automatically erases the data from the first journey (flight), if necessary from the next ones as well, thus creating a capacity to store new data in the RAM.

Despite all above-mentioned precautions an attempt at tempering therewith is still possible, when the passenger, having, by purpose, inserted the latch plate 9 into buckle assembly 9.1, takes a stroll along the aisle of an aeroplane despite the instruction of the pilot to “buckle up now”. In the 1st embodiment such manipulation can be avoided by arranging at least one of sensor 31, 32 to the seat cushion 3.1 and/or backrest 3.2 (FIGS. 4, 6) to sense the weight of the passenger. Under the load the electrical signal of sensor 31a, 32a switches over lock switch 33, 33a (FIG. 1), thus making the current flow during the journey or flight. This feature, which comes to a single operation in an accident of a motor vehicle, is too expensive for an aeroplane or a train because of the large number of seats.

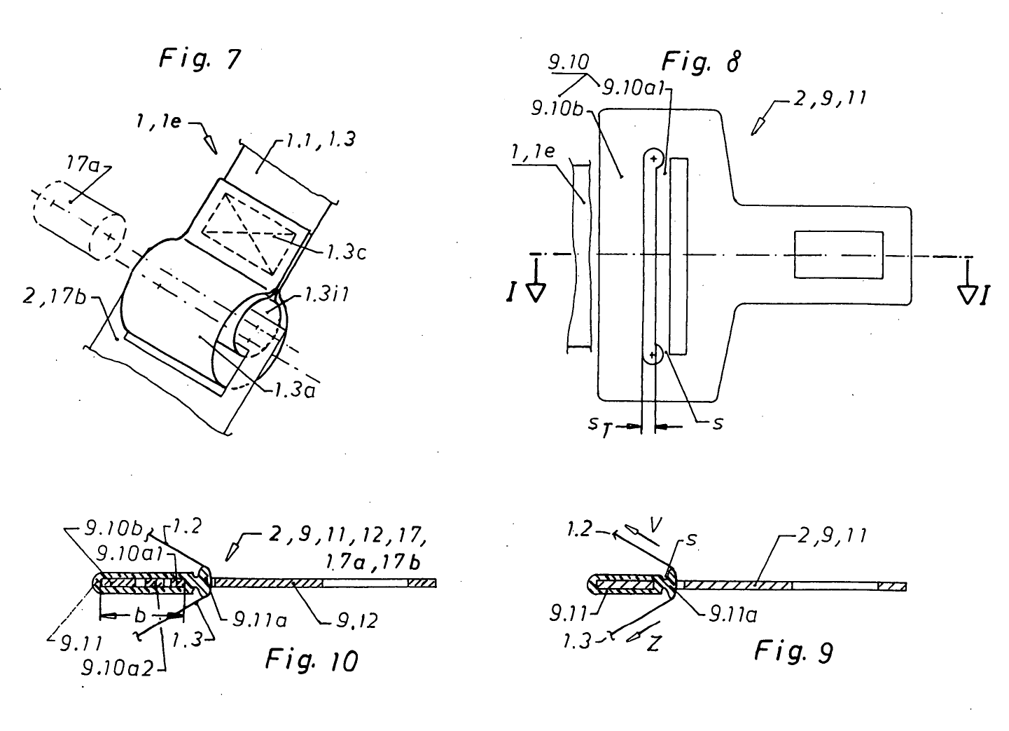

In the following low-cost embodiments (FIGS. 7 to 13, 13a) great belt force “Fₙ” (FIG. 5), resulting from the mass force of the restrained passenger in an accident or a turbulence-related flight, is exploited to fracture impact-identity elements of the restraint system, provided with sites of predetermined fracture, and/or to deform impact-identity elements thereof in order to have evidence of the seat-belt use. Moreover, these features lessen injury severities resulting from dissipation of energy linked to the broken sites of predetermined fracture.

In the 1st embodiment (FIG. 7) the outer belt-looping string 1.3a of belt portion 1.1, 1.3 houses an interior belt-looping string 1.3i1, acting as an impact-identity element characterized by tensile strength, which is lower than that of the seat belt 1, 1e and the threshold value of each of body parts, which are in contact therewith.

By means of floor fitting 17, 17a, 17b (not-shown 17b of three-point seat belt) the seat belt is anchored to the floor (vehicle floor) 6 or to the seat frame 3.3 (FIGS. 4, 6). Additionally, the floor fitting 17 of the multi-point seat belt has the functions of loosely guiding the belt portions 1.2, 1.3 and loosely retaining the latch plate 2 in resting position. The belt-looping string 1.3i1 is loosely connected to belt fitting 2, 17a, 17b. Upon the rupture of the belt-looping string 1.3i1 by large belt force the belt-looping string 1.3a is loosely retained by belt fitting 2, 17a, 17b.

It is highly recommended to use a plurality of impact-identity elements 1.3in, where n=1 to m (n=3 shown in FIGS. 11, 12), having different tensile strengths, serving as threshold values. At first the first end portions “B” of the belt-looping strings of belt portion 1.1, 1.3 are sewn together with yarn 1.3c2, the other, whose edges and the edge “A” of belt-looping string 1.3a are aligned with each other, are sewn together with yarn 1.3c1 and, finally, both end portions are sewn together with yarn 1.3c (FIG. 7).

In the 2nd embodiment (FIG. 8) the back portion 9.10 of latch plate 2, 9, 11 is subdivided into an impact-identity element 9.10a1 with sites of predetermined fracture “s” and a far stiffer remaining portion 9.10b.

In the 3rd embodiment a measurable deformation of aperture “s_{T}”, resulting from the total deformation of the impact-identity element 9.10a1, is reliable evidence. Up till now, conventional latch plates are manufactured by stamping (punching) method, which can be further applied to manufacture the latch plates 2, 9, 11, characterized by the above-mentioned features.

In the 4th embodiment (FIGS. 9, 10) the back portion 9.10 of belt fitting 2, 9, 11, 12, 17, 17a, 17b is surrounded with plastic material 9.11, having an impact-identity element 9.11a with sites of predetermined fracture “s”, which, being always in contact with the seat belt 1, 1e, is loaded by forward motions in direction “V”. However, in accidents it is sheared by large belt force or by large tension force of the belt tightener 190 in direction “Z”, thus rupturing the sites of predetermined fracture. In experiments the best shape of the impact-identity element 9.11a and the best surface with/without ribs can be determined. In case that the width “b” of back portion 9.10 is greater than that of the conventional, a plurality of impact-identity elements 9.10an, where n=1 to m (n=2 in FIG. 10) can be arranged therein.

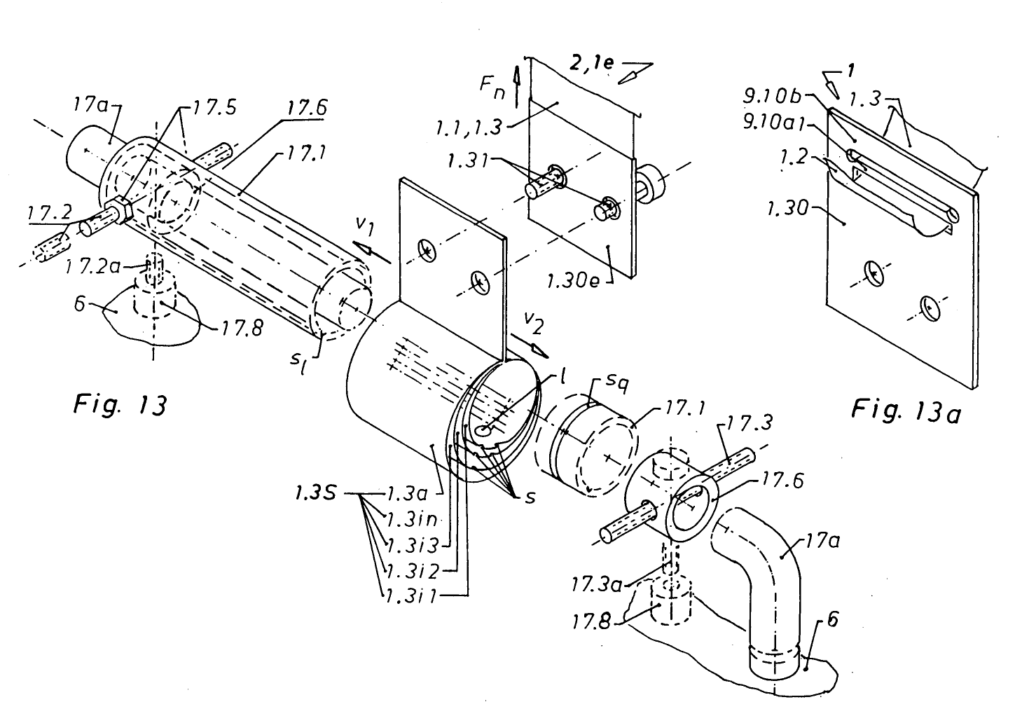

In the 5th embodiment (FIGS. 13, 13a) the features focus on replaceable parts of restraint system such as impact-identity element 17.1 and set 1.3S of impact-identity elements to save costs by facilitating assembly, disassembly and replacement in an easy manner and/or grouping

the broken parts 17.1, 1.3S, latch plate 2, 9, 11 and/or the broken D-ring 12 in the event, in which an accident almost occurs, and

the energy-absorbing parts 17.1, 1.3S, 2, 9, 11 and/or 12 for light- to heavy-weight passengers, characterized by different threshold values. Impact-identity elements 17.1 and sets 1.3S of impact-identity elements can be grouped in weight classes representing the threshold values of the passengers. To restrain for a 35 kg-heavy child one or both parts, designed for a 8 kg-heavy baby, are replaced by 35 kg-designed impact-identity elements and sets.

If the car owner has the intention to manipulate he is reluctant to replace the broken parts 17.1, 1.3S, 2, 9, 11 and/or 12. However, the car manufacturer has non-falsified evidence, which is recorded by device 30, 30a to 30e in any accident.

These features are useful for latch plate 2 as well as all floor fittings. The latch plate 2 is loosely connected to the set 1.3S of impact-identity elements made of belt webbings. In comparison with floor fitting 17, 17b the floor fitting 17a has the advantage, that upon seat adjustment in direction, denoted by arrow “v₁” or “v₂”, the position of the belt portion 1.3 to the restraint of the lower part of body remains unchanged.

The movement of the set 1.3S of impact-identity elements is limited either by pin 17.2 in direction of arrow “v₁” or by pin 17.3 in direction of arrow “v₂”. A threaded bolt 17.3, inserted through the first end portion of impact-identity element 17.1, sleeve 17.6 and floor fitting 17a, is secured by two huts 17.5 (not shown). After the projection of the set 1.3S of impact-identity elements along the impact-identity element 17.1 a second threaded bolt 17.2, inserted through the other end portion, sleeve 17.6 and floor fitting 17a, is secured by a pair of nuts 17.5. The pin 17.2 can be bolted to the side rail too. If the protruding portions of the corresponding pins 17.2, 17.3 pose danger to persons when cleaning, they are substituted by the bolts 17.2a, 17.3a, bolted into both bushes 17.8 of floor 6.

The impact-identity element 17.1, both end portions of which are sustained by two sleeves 17.6, in which at least one of sites of predetermined fracture “s₁” and “s_{q}” in longitudinal and lateral direction, is subjected to bending moment, resulting from belt force “Fₙ”. Preferably, the set 1.3S of impact-identity elements is made of metal. In contrary to belt webbings the belt-looping strings can be made of a single metal, designed with sites of predetermined fracture “s” in dependence on the shapes such as aperture, hole “1”, oblong hole, opening, corrugation or fissure and/or on the notch factors, in order to conduct the process of rupturing belt-looping strings 1.3in, as far as possible, in succession of “n” from “1 to m” and to save costs.

The belt portion 1.3, fastened to a coupling member 1.30e, of two-point- or three-point seat belt 1e is rigidly connected to the set 1.3S of impact-identity elements by force-locking connection of two bolts 1.31 with nuts (not shown). Contrarily, the belt portion 1.2, 1.3 of multi-point seat belt 1 must be loosely guided by the aperture of coupling member 1.30, back portion of which is provided Wraith an impact-identity element 9.10a1.

Although the present invention has been described and illustrated in detail, it is clearly understood that the terminology used is intended to describe rather than limit. Many more objects, embodiments, features and variations of the present invention are possible in light of the above-mentioned teachings. Therefore, within the spirit and scope of the appended claims, the present invention may be practised otherwise than as specifically described and illustrated.

What is claimed:

1. A device for a transport system, equipped with restraint systems, to verify seat-belt uses and dissipate large belt forces, where each restraint system comprises a seat belt (1, 1e), consisting of several belt portions (1.1 to 1.4), at least one latch plate (2, 9, 9a, 11), buckle assembly (4, 9.1, 9.1a), arranged to the floor (6), seat backrest frame (3.4) or seat frame (3.3), a belt tightener (190), a belt retractor (13), a D-ring (12), a floor fitting (17, 17a, 17b) and a locking mechanism (14) comprising
belt fittings (1.30, 1.30e, 2, 9, 9a, 11, 12, 17, 17a, 17b) of the seat belt (1, 1e), generally representing the D-rings (12), the floor fittings (17, 17a, 17b), the latch plates (2, 9, 9a, 11) and coupling members (1.30, 1.30e), all of which are provided with impact-identity elements (1.3in, 1.3S, 9.10an, 9.11a, 17.1), having sites of predetermined fracture,
whereby large belt forces, resulting from mass forces of belt users in the event, in which an accident almost occurs or an accident or a turbulence-related vibration occurs, are dissipated when the sites thereof are totally deformed or fractured in dependence on the magnitude of each belt force.

2. A device for a transport system, equipped with restraint systems, to detect seat-belt uses, comprising
warning lights (62, 62a), which flash to request passengers to buckle up, belt switches (9.5, 9.5a), which are located in buckle assemblies (9.1, 9.1a) of seat belts (1, 1e),
current lines (71, 71a, 75, 75a, 76), supplied with a current when switching on a current-control switch (50), wired to a main electric line (70) connected to a battery (56), and
at least one accelerometer, generally representing a sensor (52, 52a) or a control device (55) wired to the current line (71),
where the belt switches (9.5, 9.5a) monitor the seat-belt uses,
the device (30, 30a to 30c) works when the warning lights (62, 62a) flash upon non-use of the seat belts,
the warning lights (62, 62a) are indicators (62, 62a) and
during a journey belt-users are restrained by the seat belts (1, 1e), latch plates (9, 9a) of which are in plug-in connection with the respective buckle assemblies (9.1, 9.1a),
whereby in excess of a threshold value the accelerometer emits at least one electrical signal, which melts the indicators (62, 62a) of the belt-users.

3. A device for a transport system, equipped with restraint systems, to detect seat-belt uses, comprising
at least one warning light (62, 62a), which flashes to request a passenger to buckle up,
belt switches (9.5, 9.5a), which are located in buckle assemblies (9.1, 9.1a) of seat belts (1, 1e),
fuses (61, 61a),
current lines (71, 71a, 75, 75a, 76), supplied with a current when switching on a current-control switch (50), wired to a main electric line (70) to a battery (56), and
at least one accelerometer, generally representing a sensor (52, 52a) or a control device (55) wired to the current line (71),
where the belt switches (9.5, 9.5a) monitor the seat-belt uses,
the device (30, 30a to 30c) works when the warning light (62, 62a) flashes upon non-use of the seat belt and
the warning light (62, 62a) and the fuses (61, 61a) are indicators (61, 61a, 62, 62a) and during a journey belt-users are restrained by the seat belts (1, 1e), latch plates (9, 9a) of
which are in plug-in connection with the respective buckle assemblies (9.1, 9.1a),
whereby in excess of a threshold value the accelerometer emits at least one electrical signal which melts the indicators (61, 61a; 62, 62a) of the belt-users.

4. A device (30d, 30e) for a transport system, equipped with restraint systems, to monitor and record users and non-users of seat belt, comprising
at least one accelerometer, generally representing a sensor (52, 52a) or a control device (55),
belt switches (9.5, 9.5a), which, monitoring seat-belt uses, are located in buckle assemblies (9.1, 9.1a) of seat belts (1, 1e),
a screen (88),
current lines (71, 71a, 75, 75a, 76), supplied with a current when switching on a current-control switch (50), wired to a main electric line (70) wired to a battery (56), and
a microprocessor (80) provided with a program (80.3) which processes electrical signals (41.1, 42.1, 44.1 to 46.1) of all seat belts (1, 1e) and records during a journey time periods of uses of the seat belts (1, 1e) upon plug-in connection of latch plates (9, 9a) with the respective buckle assemblies and time periods of non-uses the remaining seat belts,
whereby the program (80.3) records time periods of excess of a threshold value of the accelerometer and stores it, the time periods of uses thereof and non-uses thereof, all of which are accident data “C2” and “C6”, in a RAM (80.1).

5. A device to issue a chain of evidence of uses and non-uses of seat belts as well as a method to protect the chain thereof and the accident data from manipulation according to claim 4, further comprising
belt fittings (1.30, 1.30e, 2, 9, 9a, 11, 12, 17, 17a, 17b) of the seat belt (1, 1e), generally representing the D-rings (12), the floor fittings (17, 17a, 17b), the latch plates (2, 9, 9a, 11) and coupling members (1.30, 1.30e), all of which are provided with impact-identity elements (1.3in, 1.3S, 9.10an, 9.11a, 17.1), having sites of predetermined fracture,
where the accident data, stored in the RAM (80.1), are tamperproof and the impact-identity elements (1.3in, 1.3S, 9.10an, 9.11a, 17.1) are tamperproof-sealed.

6. A device to issue a chain of evidence of uses and non-uses of seat belts as well as a method to protect the chain thereof and the accident data from manipulation according to claim 5, further comprising
warning lights (62, 62a), which flash to request passengers to buckle up, belt switches (9.5, 9.5a), which are located in buckle assemblies (9.1, 9.1a) of seat belts (1, 1e),
current lines (71, 71a, 75, 75a, 76), supplied with a current when switching on a current-control switch (50), wired to a main electric fine (70) connected to a battery (56), and
at least one accelerometer, generally representing a sensor (52, 52a) or a control device (55) wired to the current line (71),
where the belt switches (9.5, 9.5a) monitor the seat-belt uses,
the device (30, 30a to 30c) works when the warning lights (62, 62a) flash upon non-use of the seat belts,
the warning lights (62, 62a), serving as indicators (62, 62a), are tamperproof-sealed,
during a journey belt-users are restrained by the seat belts (1, 1e), latch plates (9, 9a) of which are in plug-in connection with the respective buckle assemblies (9.1, 9.1a), and
the accident data, stored in the RAM (80.1), are tamperproof.

7. A device to issue a chain of evidence of uses and non-uses of seat belts as well as a method to protect the chain thereof and the accident data from manipulation according to claim 6, further comprising
at least one warning light (62, 62a), which flashes to request a passenger to buckle up, belt switches (9.5, 9.5a), which are located in buckle assemblies (9.1, 9.1a) of seat belts (1, 1e),
fuses (61, 61a),
current lines (71, 71a, 75, 75a, 76), supplied with a current when switching on a current-control switch (50), wired to a main electric line (70) to a battery (56), and
at least one accelerometer, generally representing a sensor (52, 52a) or a control device (55) wired to the current line (71),
where the belt switches (9.5, 9.5a) monitor the seat-belt uses, the device (30, 30a to 30c) works when the warning light (62, 62a) flashes upon non-use of the seat belt, and
the warning light (62, 62a) and the fuses (61, 61a), all of which serving as indicators (61, 61a, 62, 62a), are secured in a box, which is tamperproof-sealed, of the transport system,
during a journey belt-users are restrained by the seat belts (1, 1e), latch plates (9, 9a) of which are in plug-in connection with the respective buckle assemblies (9.1, 9.1a), and
the accident data, stored in the RAM (80.1), are tamperproof

8. A device to record users and non-users of seat-belt and life of restraint systems according to claim 7, further comprising current lines (77), to each of which two sensors (14.4, 14.5) of each locking mechanism (14) are wired,
whereby the following data “C1” to “C5”
the date, the start of the journey,
the time periods of seat belt fastened, unfastened and fastened again or the time periods of seat belt unfastened,
the number of uses of each seat belt (1, 1e),
the number of belt protractions out of each belt retractor (13) and
the number of blockings the belt portion (1.4) by means of a pair of clamping shoes (14.1) of each locking mechanism (14)
are detected, updated and stored in the RAM (80.1) by the program (80.3).

9. A method to prevent manipulation according to claim 8, wherein the device is provided with lock switches (33, 33a) to impede current flow despite the plug-in connection of the latch plates with the respective buckle assemblies while the passengers don't take seat, where to each seat at least one sensor (31, 32) is arranged, which senses the weight of the seating passenger, thus emitting an electrical signal to neutralize the impediment thereof

10. A device according to claim 8, wherein multi-crashes or multi-turbulence-related vibrations are detected by a reusable accelerometer.

11. A device according to claim 10, wherein in excess of the threshold value the accelerometer emits in a signal line (86) the electrical time-collision signal (46.1), which is transformed by the program (80.3) to register the exterior temperature, the time of the collision or the turbulence-related vibration and a time-dependent curve of the speed over the duration of the accident and to record as the accident data “C6”, where, finally, the accelerometer is ready for the next registration.

12. A device according to claim 11, wherein upon the plug-in connection of the latch plate (9, 9a) with the buckle assembly (9.1, 9.1a) the belt switch (9.5, 9.5a) interrupts the current in the electric line (75, 75a) and reroutes to a signal transmitter (42).

13. A device according to claim 12, wherein a master belt switch (60) is wired to the current line (76) of all belt switches (9.5, 9.5a), to which the current-flow is interrupted when switching off the master belt switch (60) or the current flows when switching it on.

14. A device according to claim 13, wherein when the device (30d, 30e) is put into operation the current of the electric line (76) activates a signal transmitter (41) to emit to a signal line (81) an electrical start-time signal (41.1), which is transformed by the program (80.3) to set the date and the start of the journey.

15. A device according to claim 14, wherein the current activates the signal transmitter (42) to emit to two signal lines (82, 83) the electrical belt-use signal (42.1), which is transformed by the program (80.3) to set the time of the seat-belt use and to increase the counter of the seat-belt uses.

16. A device according to claim 15, wherein to the belt portion (1.4) a row of belt-lengths is arranged, distances of which are characterized by belt-protraction markers, generally representing colours, codes, metal strips or pattern, where in excess of the belt-length the sensor (14.4) emits in a signal line (84) an electrical belt-protraction signal (44.1), which is transformed by the program (80.3) to increase the number of the belt protractions out of the belt retractor (13).

17. A device according to claim 16, wherein in excess of a predetermined deceleration, serving as a threshold value, the sensor (14.5) emits in a signal line (85) an electrical belt-blocking signal (45.1), which is transformed by the program (80.3) to increase the number of the blockings, achieved by the pair of clamping shoes (14.1) of the locking mechanism (14).

18. A device according to claim 17, wherein in excess at least one of the threshold values of the seat-belt uses, belt protractions or blockings a warning to replace the worn-out parts of the respective restraint systems appears on the screen (88).

19. A device according to claim 17, wherein in excess at least one of the threshold values of the seat-belt uses, belt protractions or blockings a warning to replace the worn-out parts of the respective restraint systems ensues from flashing of a warning light (69, 62x).

20. A device according to claim 17, wherein in excess at least one of the threshold values of the seat-belt uses, belt protractions or blockings a warning to replace the worn-out parts of the respective restraint systems ensues from a voice, generally representing a sound or spoken message.

21. A device according to claim 18, wherein names of the passengers in reference to the seats, typed in a PC (90), serve as data “C7”, which are stored in the RAM (80.1) via a data line (87) of a terminal.

22. A device according to claim 19, wherein names of the passengers in reference to the seats, typed in a PC (90), serve as data “C7”, which are stored temporarily in a storage disc (92), from which the data “C7” are read upon need via a disk drive (91) and are stored in the RAM (80.1) via a data line (87a) of the transport system.

23. A device according to claim 21, wherein the data “C1” to “C7” appear on the screen (88) when activating an operating knob (89).

24. A device according to claim 21, characterized in that the data “C2” to “C6”, which are the accident data, and the data “C1”, “C3” to “C5” and “C7”, which are accident data, are stored in the RAM (80.1) and tamperproof.

25. A method to protect data from manipulation according to claim 24, wherein the accident data “C1” to “C7” are stored and secured in a blackbox (34) of the transport system

26. A method to protect data from manipulation according to claim 24, wherein the data “C1” to “C7” are stored and secured in the storage disc (92).

27. A device according to claim 21, wherein when restarting the program (80.3) the data “C1”, “C2” and “C7” are automatically deleted.

28. A device according to claim 21, wherein when restarting the program (80.3) the data “C1”, “C2” and “C7” are deleted or overwritten when activating an operating knob (89).

29. A device according to claim 8, wherein the sites of predetermined fracture of the impact-identity elements (1.3in, 1.3S, 9.10an, 9.11a, 17.1) of the belt fittings (2, 9, 9a, 11, 12, 17, 17a, 17b) have different threshold values, all of which are lower than the tensile strength of a belt-looping string (1.3a), equal to that of the seat belt (1, 1e), of a set (1.3S) of impact-identity elements.

30. A device according to claim 29, wherein the plurality of impact-identity elements (1.3in, 1.3S, 9.10an, 9.11a, 17.1) of the belt fittings (1.30, 1.30e, 2, 9, 9a, 11, 12, 17, 17a, 17b) is subdivided into at least two weight classes for light- to heavy-weight passengers, where the seat belts (1, 1e), equipped with the belt fittings (1.30, 1.30e, 2, 9, 9a, 11, 12, 17, 17a, 17b) of the corresponding weight classes, are installed in the transport system and tamperproof-sealed.

31. A device according to claim 30, wherein the impact-identity elements (1.3in, 1.3S, 9.10an, 9.11a, 17.1), where “n”=“1” to “m”, are provided with identification markers, generally representing different colours, different widths or different patterns.

32. A device according to claim 31, wherein the set (1.3S) of impact-identity elements is defined by a belt-looping string (1.3a) of the belt portion (1.1, 1.2, 1.3) of the seat belt (1, 1e) and a number of impact-identity elements (1.3in), where “n”=“1” to “m”, all of which are arranged in the belt-looping string.

33. A device according to claim 32, wherein the impact-identity elements (1.3in) and the belt-looping string (1.3a) are made of belt webbing, compound material, metal or fibre-reinforced material.

34. A device according to claim 33, wherein an end portion of the two-point- or three-point seat belt (1e) is fastened to the coupling member (1.30e) bolted to the set (1.3S) of impact-identity elements which is replaceable and loosely retained by the floor fitting (17a, 17b).

35. A device according to claim 33, wherein an end portion of the multi-point seat belt (1) is fastened to the coupling member (1.30e) bolted to the set (1.3S) of impact-identity elements which is replaceable and accommodates the latch plate (2) thereof

36. A device according to claim 35, wherein a lap belt portion of the multi-point seat belt (1) is loosely guided by an aperture of the coupling member (1.30) bolted to the set (1.3S) of impact-identity elements which is replaceable and loosely retained by the floor fitting (17a, 17b).

37. A device according to claim 36, wherein the impact-identity element (17.1), which is arranged along the floor fitting (17a) and end portions of which are fastened thereto as well as sustained by a pair of sleeves (17.6), is provided with at least one of the sites of predetermined fracture “s₁” and “s_{q}”, which are arranged in longitudinal- and lateral direction.

38. A device according to claim 37, wherein the set (1.3S) of impact-identity elements is moveable along the impact-identity element (17.1) and the movement is limited by a pair of pins (17.2, 17.3; 17.2a, 17.3a).

39. A device according to claim 33, wherein a back portion (9.10) of the belt fitting (1.30, 1.30e, 2, 9, 9a, 11, 12, 17, 17a, 17b) comprises a stiffer remaining portion (9.10b) and a number of impact-identity elements (9.10an), where “n”=“1” to “m”, with apertures “s_{T}”, which are measurable when the impact-identity elements (9.10an) are totally deformed by great belt force, and with sites of predetermined fracture “s”, which are fractured by greater belt force.

40. A device according to claim 39, wherein the back portion (9.10) is surrounded with a plastic material (9.11), having an impact-identity element (9.11a), being in contact with the seat belt (1, 1e), with sites of p)redetermined fracture “s”, which are ruptured by great belt force.

41. A method to prevent injuries and manipulation according to claim 40, wherein the impact-identity elements (9.10an), deformed by great belt force, are surrounded by the plastic material (9.11).
